(19) United States
(12) Patent Application Publication
(10) Pub. No.: US 2015/0065350 A1
(43) Pub. Date: Mar. 5, 2015

(54) SUPERCONDUCTOR COIL ARRANGEMENT

(71) Applicant: NEXANS, Paris (FR)

(72) Inventor: Achim Hobl, Rosrath (DE)

(21) Appl. No.: 14/303,718

(22) Filed: Jun. 13, 2014

(30) Foreign Application Priority Data
Sep. 3, 2013 (EP) 13 306 201.8

(51) Int. Cl. H01F 6/06; H01F 41/00

(52) U.S. Cl. CPC H01F 6/06; H01F 41/00
USPC 505/211; 505/300; 335/216; 29/599

(57) ABSTRACT

A coil arrangement formed from a stripe-shaped superconductor assembly is composed of metal substrate (3) and at least one superconductor layer (4, 5) wherein the coil arrangement is such, that in adjacent turns current flow is in opposite direction in operation, and wherein the substrate side (3) is in a region without magnetic field by sandwiching the substrate side (3) between superconductor layers (4, 5) of same current direction during operation.

### RELATED APPLICATION

This application claims the benefit of priority from European Patent Application No. 13 306 201.8, filed on Sep. 3, 2013, the entirety of which is incorporated by reference.

### BACKGROUND

1. Field of the Invention

The present invention relates to a coil arrangement of at least one stripe-shaped superconductor assembly wherein the stripe-shaped superconductor assembly can be a superconductor stripe with metal substrate and superconductor layer formed onto at least one side of the metal substrate.

The superconductor stripe can be a tape or wire. According to need one or more buffer layer(s) can be provided between the substrate and the superconductor layer. as well as onto the superconductor layer.

The metal substrate can be biaxially textured, for example, by deformation process.

The superconductor material can be a high temperature superconductor (hts) material including rare earth oxide, for example REBa₂Cu₃O₇-δ wherein RE is selected from the group consisting of rare earth elements and Yttrium, and δ is a number of greater than 0 and less than 1.

2. Description of Related Art It is well known to wind superconductor tapes or wires into a coil configuration for obtaining a compact space saving design wherein a maximum length of superconductor tape or wire requires as little volume as possible

A particular application of such compact coil arrangement of superconductor stripes such as tapes or wires is in resistive fault current limiters. Superconducting fault current limiters make use of the unique transition characteristics of superconducting material. When a fault occurs in a power transmission system connected with a resistive superconductor fault current limiter, the current density in the superconductor material exceeds the critical current density of the material, and the superconductor material undergoes transition from its superconducting state into its normal resistive state thereby limiting the current flow.

Preferably in the coil arrangement the current path is designed such that in adjacent turns of the coil current flow is in opposite direction in order to minimize induction.

Such a coil arrangement wherein the current path is designed such that current flow in adjacent turns is in opposite direction is also referred to “coil arrangement of low inductance”.

In the well-known bifilar superconductor coil arrangement the superconductor tape or wire changes direction at one end of the coil, also referred to reversal point, and is returned in parallel to the first winding to the opposite end of the coil, i.e. the starting point of the coil winding, Due to the bifilar winding current flow and, as a consequence, the orientation of the magnetic field induced by the current flow is in opposite direction in adjacent turns. Since the magnetic fields are in opposite direction the “sum” of the magnetic fields is about zero and induction in the coil arrangement is minimized.

There are known helical bifilar coils and flat spiral bifilar coils, so called pancake coils. A typical example of a bifilar pancake coil is disclosed in EP 1 797 599 B1.

A typical problem in bifilar coil winding, irrespectively whether helical or pancake arrangement, is that the starting and end points of the winding, i.e. current input and output, are very close to each other, so that all of the voltage applied across the coil appears between these two points and makes provision of good electrical insulation necessary for avoiding short-circuit.

US 2011/011O198 A1 relates to a flat spiral bifilar coil arrangement with improved distance between current input and current output. For obtaining increased distance two or more superconductor tapes or wires are arranged on a common plane and are shaped to form a common coil winding, wherein each of the superconductor tapes or wires form a bifilar structure with the reversal point of each bifilar structure being located around the center of the spiral. in the result a larger distance between the starting and end point of each bifilar structure of the coil assembly can be obtained

U.S. Pat. No. 6,275,365 B1 relates to a fault current limiter composed of a plurality of bifilar pancake coils. Each pancake coil is separated by an insulation layer and is wound from the same continuous length of superconducting tape. The individual coils are stacked on top of each other along a longitudinal axis for obtaining a relatively compact superconducting fault current limiter with minimized total inductance.

Another approach for obtaining a coil arrangement with minimized inductance is disclosed in EP 2 472 532 A1. According to this approach a hts tape or wire is wound onto two adjacent longitudinal axes in a manner that adjacent turns of the first axis show current flow in opposing directions wherein at least two turns on the first axis are connected in series via at least one turn on the second axis. The resulting coil arrangement is monofilar rather than bifilar thereby avoiding change of direction at one end of the coil (i.e. the reversal point) and, further, the maximum voltage drop between adjacent turns is only a fraction of the voltage drop across the entire coil.

In the known bifilar coil winding of superconductor stripes the substrate side is oriented in the same direction and points either inwards or outwards of the coil. In such arrangement the substrate side of a first turn faces the superconductor layer side of the adjacent turn with opposite current flow.

As set out above conventional bifilar coils with substrate orientation towards the same direction are advantageous in that the inductance is only low since the overall sum of the magnetic fields is zero.

However, this situation is completely different when considering local parts of such conventional bifilar coil. In local parts significant local magnetic fields exist between adjacent turns with opposite current flow so that the substrate of a first turn which faces the superconductor layer of the adjacent turn, is in a region of magnetic field. Such an exposition of metal substrates to magnetic field is disadvantageous in particular in AC applications due to the changing magnetic field. Interaction of the magnetic field with the metal of the substrate leads to considerable AC losses due to both hysteretic and eddy current effects. These AC losses are particularly significant in cases where the metal is ferromagnetic. For example, Nickel and its alloys which are commonly used as metal substrate for superconductor stripes such as known as coated conductors, are typical ferromagnetic materials.

These power losses cause high cryogenic requirements and consequently increased costs.

AC losses due to hysteretic and eddy current effects are a problem in any superconductor coil arrangement wherein the superconductor material, irrespectively whether low or high temperature superconductor, is adjacent to a normally conductive metal, in particular ferromagnetic metal.

### OBJECTS AND SUMMARY

It was the object of the present invention to provide a coil arrangement of low inductance, such as for example a bifilar coil arrangement, for superconductor stripes comprising a metal substrate and deposited thereon a superconductor layer, having reduced AC losses along the coil.

This object is solved by a coil arrangement of at least one stripe-shaped superconductor assembly with metal substrate and superconductor layer formed onto at least one side of the metal substrate wherein the at least one stripe-shaped superconductor assembly is formed into a coil arrangement wherein in adjacent turns current flow is an opposite direction in operation, and wherein in the stripe-shaped superconductor assembly the metal substrate is sandwiched between superconductor layers with same current flow direction in operation.

According to the coil arrangement of the present invention the substrate side of the stripe-shaped superconductor assembly is sandwiched between two superconductor layers.

In this arrangement the current path of the coil is formed by a sandwich structure with the metal substrate side being sandwiched between two superconductor layers.

Further, in adjacent turns of the coil arrangement with opposite direction of current flow the superconductor layer side of a first turn faces the superconductor layer side of the adjacent turns. i.e. the turn following the first turn and the turn preceding the first turn.

Due to this sandwich architecture the substrate side of each turn is positioned in a region without magnetic field, and only in the region between the superconductor layer side of adjacent turns of the coil winding a magnetic field is generated.

In principle the coil arrangement of the present invention is suitable for any coil winding wherein in adjacent turns current flows in opposite direction.

The coil arrangement can be a conventional bifilar coil winding with the stripe-shaped superconductor assembly being wound into a first coil part and is returned in parallel to the first coil part forming the second coil part.

Two or more stripe-shaped superconductor assemblies can be wound into coil configuration side by side and being returned. In this case, the two or more stripe-shaped superconductor assemblies or some of them can run together in a common reversal point and being returned from said common reversal point.

The present coil arrangement is suitable for any superconductor stripe comprising a stripe-shaped metal substrate wherein at least one side of the metal substrate is coated with a superconductor layer.

According to one embodiment of the present invention the stripe-shaped superconductor assembly can be composed of two superconductor stripes, each superconductor stripe comprising a metal substrate and a superconductor layer formed thereon. The two superconductor stripes are arranged in parallel with the substrate sides facing each other and the superconductor layer sides pointing outwards.

When such stripe-shaped superconductor assembly is formed into a coil winding of low inductance with current flow in opposite direction in adjacent turns, the superconductor layer side of a given turn faces the superconductor layer side of the adjacent turns with current flow in opposite direction and the metal substrate side being in a position of no magnetic field.

According to another embodiment of the present invention the stripe-shaped superconductor assembly can be composed of a superconductor stripe wherein on both, the top and bottom side, of the metal substrate a superconductor layer is formed.

According to need one or more buffer layers can be provided between substrate and the superconductor layer and/or onto the superconductor layer. Such superconductor stripes, materials therefore and fabrication methods are known per se.

The superconductor material can be anyone of low and high temperature superconductor materials and MgB₂. High temperature superconductor materials are those having a critical temperature above the temperature of liquid nitrogen (77 K.). HTS materials are preferred for example in view of the use of liquid nitrogen as cooling medium which is comparatively cheaper than, e.g., liquid helium.

Examples of suitable hts materials are rare earth oxides, for example REBa₂ Cu₃O_{7-δ}, wherein RE is at least one from the group consisting of rare earth elements and Yttrium, and δ is a number of greater 0 and less than 1, Bismuth-Strontium-Calcium-Copper-Oxide superconductors (BSCCO) and Thallium based superconductors,

Typical buffer layers are metal oxides such as CeO₂, YSZ (Yttria stabilized Zirconia), Y₂O₃ and SrTiO₃ as well as metals such as Silver. Nickel etc.

Preferably a layer of non-ferromagnetic metal is provided onto the superconductor. layer, e.g. silver, gold, copper.

The metal material for the substrate can include metal and metal alloys such as Nickel, Nickel-Tungsten, Nickel-Chromium, Nickel-Copper, Nickel-Vanadium or Hasteiloy. Stainless steel or any other suitable normally conductive metal or metal alloy.

For the fabrication of the coil arrangement of the present invention the stripe-shaped superconductor assembly can be composed of two superconductor stripes wherein a superconductor layer is provided on one side of the metal substrate.

In this case the current path is formed by two superconductor stripes wound in parallel into the coil arrangement of the present invention, wherein the substrate side of each superconductor stripe faces each other.

The superconductor layer side of each superconductor stripe points towards the adjacent turns with current flow in opposite direction in operation.

Considering the overall coil arrangement in this embodiment the current path is defined by two individual superconductor stripes each comprising a metal substrate and a superconductor layer applied onto one side of the metal substrate.

There can be a space between the two individual superconductor stripes of the stripe-shaped superconductor assembly.

A spacer of electrically insulating material can be provided in the space between the two superconductor stripes. The electrically insulating material can be plastics such as Teflon, Polyimide, Aramid etc. or any other electrically insulating material which is stable at low temperature.

According to another embodiment the two individual superconductor stripes can be jointed via their substrates, for example by soldering or gluing etc.

According to yet another embodiment the stripe-shaped superconductor assembly can be composed of a superconductor stripe wherein the substrate is provided with a superconductor layer on both the top and bottom side of the metal substrate.

Preferably, the turns of the coil arrangement of the present invention are electrically insulated by providing an electrically insulating material between the turns. The material can be one as referred to above.

In a preferred embodiment of the present invention the superconductor layer of the superconductor stripe is a rare-earth-oxide based hts material as defined above. In particular, the hts conductor stripe is one known as “coated conductor” using YBCO based hts material.

Generally, there are two main approaches for the production of superconductor stripes such as of coated conductor-type including YBCO coated conductors.

According to the first approach metal substrates are used which are untextured (random crystal orientation). In this case a buffer layer must be applied in a suitable crystal orientation for serving as a template for transferring the required crystal orientation to the superconductor layer to be grown.

According to the second approach metal substrates are used which have been treated to be textured, preferably biaxially textured i.e. in axial direction within the plane and perpendicularly to the plane.

In this case the substrate as such can serve as template. Biaxially textured metal substrates can be fabricated by rolling and heat treatment and are known as rolling assisted biaxially textured substrates (RABiTS).

The metal material for the substrate should meet a number of criteria It should be thermally and chemically stable at elevated temperatures at which the superconductor deposition and formation is carried out. Further, it should be flexible and have good yield strength in order to provide appropriate support for the final conductor. When using the RABiTS route the metal must be one in which a suitable texture can be generated by rolling and heat treatment.

For example, in the production of YBCO coated conductors Ni, Ni alloys, Ag and Ag alloys are suitable for fabricating the biaxially textured substrate via the RABiTS route since these materials allow generation of the required texture for growing the hts layer thereon in the desired crystal alignment. In view of costs Ni and Ni alloys are widely used nowadays.

However, Nickel and Nickel alloys have the drawback to be ferromagnetic with the disadvantageous consequence of significant AC losses in conventional bifilar coil winding as set out above.

According to the present invention the disadvantage in view of AC losses of substrates made of metals, in particular ferromagnetic metals such as Nickel and Nickel alloys, can be overcome.

### BRIEF DESCRIPTION OF DRAWINGS

The present invention is now illustrated in more detail by reference to the accompanying figures, wherein:

FIG. 1 shows a bifilar pancake coil of prior art EP 2 041 809 81;

FIG. 2 shows schematically the substrate orientation of prior art bifilar coils such as in prior art pancake coil shown in FIG. 1, as well as the magnetic field variation between two adjacent turns along the coil;

FIG. 3 shows schematically an embodiment of substrate orientation and winding arrangement according to the present invention as well as the magnetic field variation between adjacent turns along the coil; and

FIG. 4 shows schematically a further embodiment of substrate orientation and winding arrangement according to the present invention, as well as the magnetic field variation between adjacent turns along the coil.

### DETAILED DESCRIPTION

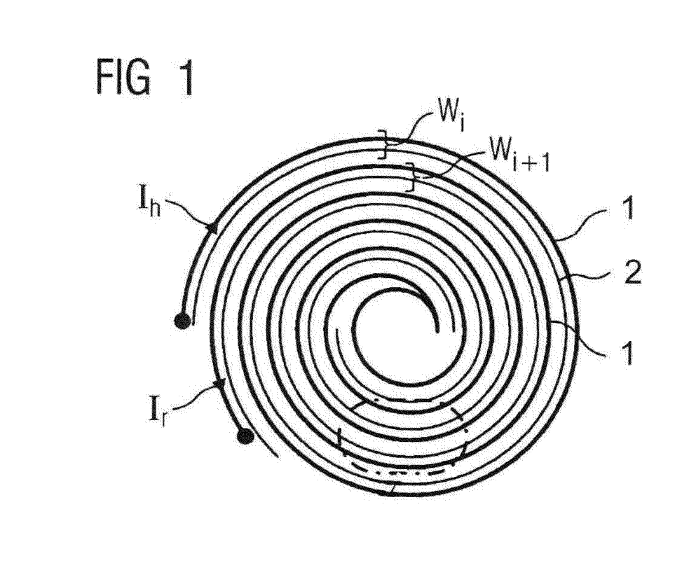

FIG. 1 shows a prior art bifilar pancake coil winding of a hts tape of coated- conductor type 1 with Ih denoting current input, Ir current output, Wi and Wi+1 adjacent turns, as well as spacer 2 running in parallel to the hts tape 1 for separating and insulating adjacent turns.

In this coil arrangement the metal substrate side of the hts tape of coated conductor type faces outwards and the his layer insides of the arrangement. Consequently, in adjacent turns Wi and Wi+1 the hts layer of turn Wi is directed towards the substrate side of turn Wi+1.

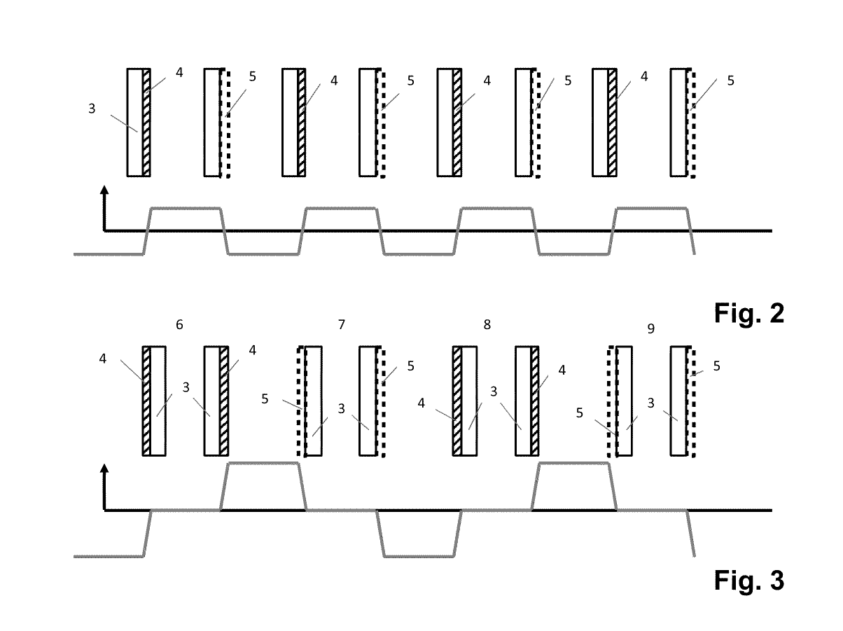

A cross-section of the resulting coil arrangement of FIG. 1 is shown in FIG. 2 with reference no, 3 denoting the substrate, 4 the superconductor layer with current flow in first direction and 5 superconductor layer with current flow in opposite direction, the resulting magnetic fields between adjacent turns along the coil arrangement being illustrated in the diagram below.

As follows from the diagram local magnetic fields exist between adjacent turns (with alternating direction corresponding to alternating direction of current flow), Seen along the overall coil winding the sum of the local magnetic fields with alternating direction is about zero, whereas between adjacent turns local magnetic fields with alternating direction exist. Consequently, in such an arrangement the substrate sides are exposed to the magnetic field generated by the current flow. Due to the influence of the magnetic field AC losses are caused in the metal substrate due to hysteretic and eddy current effects. These AC losses are particularly considerable in cases of substrates made of ferromagnetic materials such as nickel and nickel alloys widely used in the production of superconductor stripes such as those of coated-conductor type.

A cross-section through a section of a coil winding of the present invention is shown in FIG. 3.

In this embodiment the coil arrangement of the present invention is obtained by winding a stripe-shaped superconductor assembly composed of two superconductor stripes in parallel, wherein the substrate sides 3 of the two superconductor stripes are oriented towards each other and the superconductor layers 4, 5 pointing in opposite directions. In this embodiment the current path is defined by the two superconductor stripes with superconductor layer 4 indicating current flow in a first direction and superconductor layer 5 in opposite direction.

Shown are four turns 6, 7, 8 and 9 of the coil arrangement, wherein current flow in the first and third turn 6, 8 is in a first direction, and in the second and fourth turn 7, 9 in opposite direction.

Within each turn 6, 7, 8, 9 the substrate sides 3 are oriented towards each other and between two adjacent turns 6, 7; 7, 8; 8, 9 the respective superconductor layer side 4, 5 faces each other.

The variation of magnetic field along the coil arrangement of FIG. 3 is shown in the diagram below the cross-section. In the region between the two substrate sides 3 of each turn 6, 7, 8, 9 the magnetic field is zero, whereas in the region between the superconductor layer side 4, 5 of adjacent turns 6, 7; 7, 8; 8, 9 magnetic field exists with opposite direction between consecutive turns 6, 7 and 7, 8 as well as 7, 8 and 8, 9, respectively.

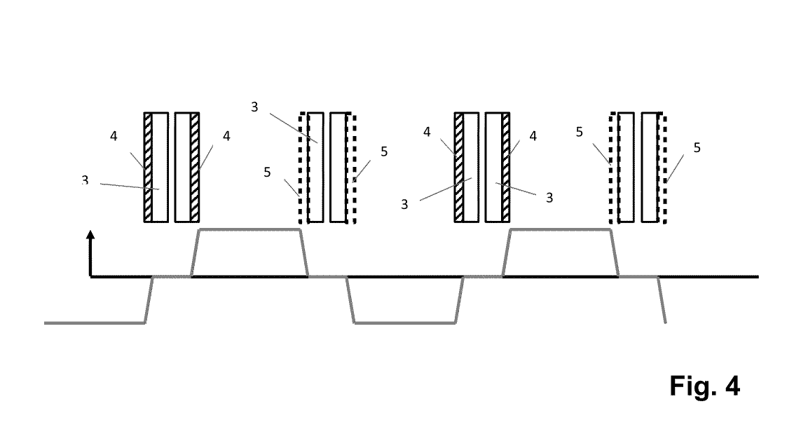

A variation of the embodiment of coil arrangement according to the present invention of FIG. 3 is shown in FIG. 4. In this variation the distance between the substrates 3 of the individual turns 6, 7, 8, 9 is closer than in the variation of FIG. 3. The course of magnetic field of the variation of FIG. 4 is shown in the diagram of FIG. 4.

According to a further embodiment it is also possible to join he substrate sides 3 of the two individual superconductor stripes forming the current path of the coil, Such joining can be a accomplished, for example, by soldering or gluing.

According to yet another embodiment it is also possible to use a superconductor stripe wherein a superconductor layer is provided on both the top and bottom faces of the substrate stripe.

In the coil arrangement of the present invention with opposite current flow direction in adjacent turns the substrate side of the superconductor stripe(s) wound into the coil arrangement is located in a region without magnetic field. In the result AC losses due to hysteresis effects and eddy currents caused by the influence of the changing magnetic field onto the metal material of the substrate, are prevented.

Such AC losses are particularly relevant in case of ferromagnetic metal material. The benefits of the present invention are particularly evident when YBCO coated conductors are used for forming the coil arrangement with RABiT substrates made of Nickel or Nickel alloys. Nickel and Nickel alloys are widely used in view of their good texturing capability and low costs, but are ferromagnetic.

As is evident, with current flow in opposite direction in adjacent turns, such as in bifilar winding, the present invention is advantageously applicable for any coil fabrication using superconductor stripes with metal substrates without being restricted to conventional bifilar coil winding.

1. Coil arrangement comprising:
at least one stripe-shaped superconductor assembly with meta substrate; and
superconductor layer formed onto at least one side of the metal substrate
wherein the at least one stripe-shaped superconductor assembly is formed into a coil arrangement
wherein in adjacent turns current flow is in opposite direction in operation, and
wherein in the stripe-shaped superconductor assembly the metal substrate is sandwiched between two superconductor layers of same current direction.

2. Coil arrangement according to claim 1, wherein the coil arrangement comprises two or more stripe-shaped superconductor assemblies which are wound side by side into the coil arrangement.

3. Coil arrangement according to claim 1, wherein the stripe-shaped superconductor assembly is composed of two superconductor stripes, each superconductor stripe having a metal substrate and provided onto one side of the metal substrate a superconductor layer wherein the superconductor stripes are arranged in parallel with the substrate sides facing each other and the superconductor layer sides pointing outwards.

4. Coil arrangement according to claim 3, wherein the superconductor stripes of the stripe-shaped superconductor assembly are jointed at their substrate sides.

5. Coil arrangement according to claim 1, wherein the stripe-shaped superconductor assembly comprises a metal substrate and a superconductor layer onto both the top and bottom side of the substrate.

6. Coil arrangement according to claim 1, wherein the metal material of the substrate is a ferromagnetic metal.

7. Coil arrangement according to claim 1, wherein the superconductor material is a high temperature superconductor material.

8. Coil arrangement according to claim 7, wherein the high temperature superconductor material has the general formula REBa₂ Cu₃O_{7-δ} wherein RE is at least one selected from the group consisting of rare earth elements and Yttrium, and δ is a number of greater than 0 and less than 1.

9. Coil arrangement according to claim 8, wherein the superconductor material is of YBCO type.

10. Coil arrangement according to claim 1, wherein the superconductor stripe is a coated conductor comprising a stripe-shaped metal substrate and a high temperature superconductor layer provided onto at least one side of the stripe-shaped metal substrate and, optionally, at least one buffer layer between the metal substrate and the high temperature superconductor layer and/or onto the at least one high-temperature superconductor layer.

11. Coil arrangement according to claim 1, wherein the metal substrate is biaxially textured.

12. Coil arrangement according to claim 1, wherein the coil has a helical or spiral shape.

13. Coil arrangement according to claim 1, wherein there is at least one layer made of non-ferromagnetic metal on top of each superconductor layer.

14. Coil arrangement according to claim 1, wherein the at least one stripe-shaped superconductor assembly is formed into a bifilar winding.

15. A method of making a fault current limiters, said method comprising the steps of:
employing a coil arrangement according to claim 1 in the production of said fault current limiters.
